(19) United States
(12) Patent Application Publication
(10) Pub. No.: US 2026/0023692 A1
(43) Pub. Date: Jan. 22, 2026

(54) MEMORY INTERFACES AND CONTROLLERS

(71) Applicant: TEXAS INSTRUMENTS INCORPORATED, Dallas, TX (US)

(72) Inventors: Mihir Mody, Bangalore (IN); Prithvi Shankar Yeyyadi Anantha, Bangalore (IN); Deepshikha Gusain, New Delhi (IN); Mohammad Asif Farooqui, Bangalore (IN)

(21) Appl. No.: 18/775,936

(22) Filed: Jul. 17, 2024

(51) Int. Cl. G06F 12/14

(52) U.S. Cl. CPC G06F 12/1408; G06F 12/1458

(57) ABSTRACT

Various examples disclosed herein relate to controlling access to non-volatile memory devices. In an example embodiment, a device is provided. The device includes a first memory interface controller, a second memory interface controller, a multiplexer coupled to the first and second memory interface controllers, and a processing core coupled to the first and second memory interface controllers and to the multiplexer. The multiplexer is configured to selectably couple a first of the first and second memory interface controllers to a first memory and to selectably couple a second of the first and second interface controllers to a second memory. The processing core is configured to cause the multiplexer to selectably couple the first of the first and second memory interface controllers to the first memory and to selectably couple the second of the first and second memory interface controllers to the second memory.

### TECHNICAL FIELD

This relates generally to controlling read and write access to non-volatile memory devices.

### BACKGROUND

Microcontroller units (MCUs) are designed to run software programs and perform functions enabled by running the software programs. To do so, MCUs can include processing cores configured to execute software and memory coupled with the processing cores that stores the instructions and data of the software. For example, MCUs can have one or more processing cores that communicate with random access memory (RAM) to execute such software programs. If a software program is too large to be executed from RAM, the MCU may additionally utilize non-volatile memory, such as flash memory, that has a larger capacity to store instructions and data related to the software. MCUs generally execute software programs with greater speed and reduced latency from RAM, however, increasing complexity and size of the programs may make it beneficial for the MCU to execute from RAM and/or non-volatile memory to perform the task.

When utilizing non-volatile memory, a processing core may read or write from a given memory. In many existing solutions, non-volatile memory devices include multiple memory banks, one bank from which program instructions and/or data is read, and another from which program instructions and/or data is written. In some solutions, such non-volatile memory devices include a third memory bank from which program instructions are executed, which may be referred to as execute-in-place (XIP). However, such solutions are costly due to the need for multiple memories or memory banks thereof. Other solutions may utilize a single non-volatile memory. In such cases, a prioritization mechanism is required to determine which read and write requests may take priority over the others. Although multiple requests from a single processing core can be interleaved, such solutions fail to account for performance inefficiencies when prioritizing one request over another.

### SUMMARY

Disclosed herein are improvements to control of access to non-volatile memory based on access requests from one or more processing cores. An access request may include a read request, a write request, and/or an execution request. In environments including multiple processing cores that may each attempt to access multiple non-volatile memories in executing program code, control of access to one of multiple memories may be performed to reduce latency and increase processing throughput. In an example embodiment, a device is provided. The device includes a first memory interface controller, a second memory interface controller, a multiplexer coupled to the first and second memory interface controllers, and a processing core coupled to the first and second memory interface controllers and to the multiplexer. The multiplexer is configured to selectably couple a first of the first and second memory interface controllers to a first memory and to selectably couple a second of the first and second interface controllers to a second memory. The processing core is configured to cause the multiplexer to selectably couple the first of the first and second memory interface controllers to the first memory and to selectably couple the second of the first and second memory interface controllers to the second memory.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example system for controlling access to non-volatile memory devices in accordance with an implementation.

FIG. 2 illustrates a series of steps for controlling access to memory devices in an implementation.

FIG. 3 illustrates an example sequence diagram demonstrating access between elements of a system in accordance with an implementation.

FIG. 4 illustrates an example architecture of components of a system configurable to perform memory access control in an implementation.

FIG. 5 illustrates an example flow chart for controlling access to memory devices in an implementation.

FIG. 6 illustrates example aspects of non-volatile memory devices in an implementation.

FIG. 7 illustrates a computing device that may be used in accordance with some examples of the present technology.

The drawings are not necessarily drawn to scale. In the drawings, like reference numerals designate corresponding parts throughout the several views. In some examples, components or operations may be separated into different blocks or may be combined into a single block.

### DETAILED DESCRIPTION

Discussed herein are enhanced components, techniques, and systems related to control of access to memory by one or more processing cores. A processor or processing core can be tasked with executing software to enable functionality of an application, device, or system. While the processor may copy some code and data to internal (e.g., volatile) memory for execution, it may not be optimal to copy all of the code and data to the internal (e.g., volatile) memory due to design restraints, costs, and other considerations. Thus, non-volatile memory, such as flash memory, may be included in a system external to the processor. In such systems, some code and data may be copied from the non-volatile memory to the internal memory (e.g., RAM) at runtime, while other code and data may remain in the external non-volatile memory (e.g., flash memory) at runtime. The processor may attempt to access both the internal memory and the external memory during execution of software. In various examples, a processor may have multiple processing cores simultaneously executing code and performing reads and writes using the external flash memory. Problematically, previous solutions fail to provide prioritization and control techniques for requests among multiple processing cores.

A system disclosed herein includes multiple memory interface controllers capable of reading from and/or writing to multiple non-volatile memory devices (e.g., flash memory devices) and a multiplexer configured to provide data paths between the memory interface controllers and the non-volatile memory devices. Processing or control circuitry may be configured to identify a data path between a memory interface controller and a non-volatile memory device for a given access request and may be configured to control, via the multiplexer, the data paths such that the memory interface controllers can read and/or write to either or both non-volatile memory devices at various times. Advantageously, the system may not only enable concurrent access to the non-volatile memory devices but also reduce design area space and cost based on using the multiplexer to direct access between the controllers and memory devices. Additionally, such use of non-volatile memory devices and memory interface controllers may reduce load on processing cores executing program applications and enabling primary functions of the system.

In an example embodiment, a device is provided. The device includes a first memory interface controller, a second memory interface controller, a multiplexer coupled to the first and second memory interface controllers, and a processing core coupled to the first and second memory interface controllers and to the multiplexer. The multiplexer is configured to selectably couple a first of the first and second memory interface controllers to a first memory and to selectably couple a second of the first and second interface controllers to a second memory. The processing core is configured to cause the multiplexer to selectably couple the first of the first and second memory interface controllers to the first memory and to selectably couple the second of the first and second memory interface controllers to the second memory.

In another example, a device is provided that includes one or more computer-readable storage media and program instructions stored on the one or more computer-readable storage media, that, when executed by a processing system, direct the processing system to perform various functions. For example, the program instructions may direct the processing system to read an indicator from one or more of a first memory and a second memory and cause a multiplexer to selectably couple a first of first and second memory interface controllers to the first memory and to selectably couple a second of the first and second memory interface controllers to the second memory based on the indicator.

In yet another embodiment, a method is provided. The method includes reading an indicator from one or more of a first memory and a second memory and causing a multiplexer to selectably couple a first of first and second memory interface controllers to the first memory and to selectably couple a second of the first and second memory interface controllers to the second memory based on the indicator.

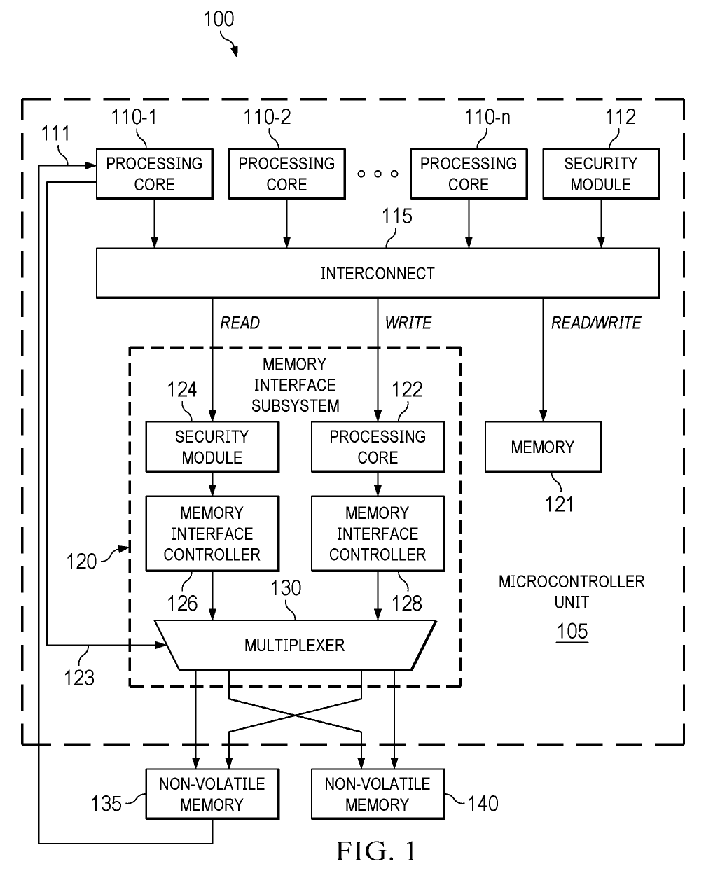

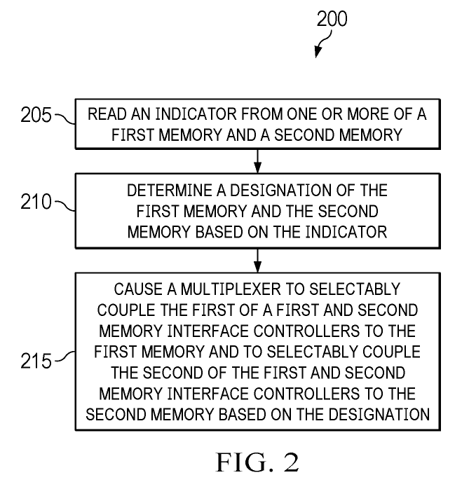

FIG. 1 illustrates an example system for controlling access to flash memory devices in accordance with an implementation. FIG. 1 shows system 100, which includes microcontroller unit (MCU) 105, non-volatile memory 135, and non-volatile memory 140. MCU 105 includes processing cores 110-1, 110-2, and 110-n (collectively processing cores 110), security module 112, interconnect 115, memory interface subsystem 120, and memory 121. Memory interface subsystem 120 includes processing core 122, security module 124, memory interface controllers 126 and 128, and multiplexer (MUX) 130. In various embodiments, MCU 105 may be configured to execute program instructions stored in memory 121 and/or non-volatile memories 135 and 140 and perform access control processes, such as process 200 of FIG. 2.

System 100 is representative of a processing system that includes various hardware, software, and firmware elements configured to execute access processes and to enable functionality based on the execution thereof. In various examples, the elements of system 100 are onboard a chip (i.e., a system-on-chip (SoC)). In that regard, MCU 105 of the system 100 may be implemented as one or more integrated circuit devices arranged in one or more chips or other suitable form factor. In some examples, some elements may be located off-chip relative to other elements onboard the chip, such as non-volatile memories 135 and 140. System 100 may be coupled with one or more peripheral devices that can obtain data from elements of system 100, such as from executions of application code, to enable functionality of the one or more peripheral devices.

System 100 includes MCU 105, which may include various processing devices and memory devices from which program instructions and data can be read and to which program instructions and data can be written. More specifically, MCU 105 may include a number of processing cores 110, a security module 112, an interconnect 115 coupled to the processing cores 110 and the security module 112, a memory interface subsystem 120 coupled to the interconnect 115, a memory device coupled to the interconnect 115, memory 121, and multiple memory devices, non-volatile memories 135 and 140, coupled to the memory interface subsystem 120.

Processing cores 110 may be representative of one or more processors, processing cores or processor cores, or processing circuitry capable of executing software and firmware, such as program instructions (e.g., application code, loadable instructions, read-only data, execute-in-place (XIP) code, and the like). Such processor(s) may include microcontrollers, digital signal processors (DSPs), general purpose processing units, central processing units (CPUs), application specific processors or circuits (e.g., ASICs), and logic devices (e.g., FPGAs), as well as other types of processing devices, combinations, or variations thereof. In various examples, processing cores 110 may attempt to access memory 121, non-volatile memory 135, and/or non-volatile memory 140 via interconnect 115 to read from or write to a given memory device.

Security module 112 may be representative of a processor, hardware accelerator, or other processing device configured to perform safety and security operations on data being read from memory 121 by one or more of processing cores 110 or peripheral devices. In various examples, security module 112 may identify a read request by processing cores 110, obtain data associated with the read request, and perform a safety and security operation on the data to verify that the data is not suspicious or malicious.

Memory 121 may be representative of computer-readable storage media located on MCU 105. For example, memory 121 may be representative of a random access memory (RAM), tightly-coupled memory (TCM), or another type of memory. Although only one block is illustrated in system 100, memory 121 may be implemented as multiple memories functioning in an integrated or separate manner. Memory 121 may store program instructions and data. The program instructions may include application code, such as instructions that, when executed by processing cores 110, enable functionality. The data may include results and/or other information related to the program instructions, loadable instructions, XIP code, or the like. Processing cores 110 may access memory 121 via interconnect 115 to execute code thereon.

Some program instructions may be initially stored in one or more of non-volatile memory 135 and non-volatile memory 140 and copied to memory 121 for execution by processing cores 110, whereas XIP code stored on non-volatile memory 135 and/or non-volatile memory 140 may configured to be executed directly out of non-volatile memory 135 and/or non-volatile memory 140 without first being copied to memory 121. In executing either set of program instructions, processing cores 110 may attempt to access memory 121 or the flash memory devices. An access request or attempt may refer to a read request whereby processing cores 110 reads instructions or data from one or more addresses of memory 121, non-volatile memory 135, or non-volatile memory 140 to perform processing or computations using the instructions or data, or the access attempt may refer to a write request whereby processing cores 110 writes data to one or more addresses of memory 121, non-volatile memory 135, or non-volatile memory 140.

Memory interface subsystem 120 may be representative of one or more components configured to provide processing cores 110 with access to non-volatile memories 135 and 140 for the execution of application code thereon. In an example, memory interface subsystem 120 may include processing core 122 and security module 124, representative of one or more processors, processing circuits, or hardware accelerators (HWAs), which may be coupled to receive write requests and read requests (i.e., access requests), respectively, from processing cores 110 and coupled to provide such requests to memory interface controllers 128 and 126, respectively, to provide access to non-volatile memory 135 and/or non-volatile memory 140 based on the access requests. Specifically, processing core 122 may be coupled to interconnect 115 to receive write requests from one or more of processing cores 110, and security module 124 may be coupled to interconnect 115 to receive read requests from one or more of processing cores 110. Processing core 122 may be coupled to provide the write requests to memory interface controller 128, while security module 124 may be coupled to provide the read requests to memory interface controller 126.

Memory interface controllers 126 and 128 may be representative of devices capable of communicating with non-volatile memories 135 and 140 to read from and write to non-volatile memories 135 and 140, respectively. In various examples, memory interface controllers 126 and 128 may include one or more serial peripheral interfaces (SPIs), expanded serial peripheral interfaces (xSPIs), octal serial peripheral interfaces (OSPIs), or the like. In an example where non-volatile memories 135 and 140 include flash memory devices, memory interface controllers 126 and 128 may be representative of flash interface controllers. In various examples, memory interface controller 126 may be configured to perform access controls for read requests from processing cores 110 while memory interface controller 128 may be configured to perform access controls for write requests from processing cores 110. Prior to performing read requests, security module 124 may be configured to perform safety and security operations on data or instructions being read from either or both non-volatile memories 135 and 140. The write capabilities may include firmware-over-the-air (FOTA) updates, data flash, EEPROM emulation, XIP write, and the like.

Memory interface subsystem 120 may further include multiplexer 130 coupled to memory interface controllers 126 and 128 and to non-volatile memories 135 and 140. Multiplexer 130 may control data paths between memory interface controllers 126 and 128 and non-volatile memories 135 and 140. More specifically, multiplexer 130 may include a first data path between memory interface controller 126 and non-volatile memory 135, a second data path between memory interface controller 126 and non-volatile memory 140, a third data path between memory interface controller 128 and non-volatile memory 135, and a fourth data path between memory interface controller 128 and non-volatile memory 140. Processing core 110-1 may be coupled to multiplexer 130 and may be configured to control the data paths via enable signal 123, such that for a given access request, a memory interface controller can read from or write to a flash memory based on enable signal 123 provided to multiplexer 130 by processing core 110-1 In this way, memory interface controller 126 can communicate with either or both non-volatile memory 135 and non-volatile memory 140 for a given read request, and memory interface controller 128 can communicate with either or both of non-volatile memory 135 and non-volatile memory 140 for a given write request. In various examples, processing core 110-1 may control the data paths based on an indicator (active indicator 111) stored in non-volatile memory 135. In some such examples, the indicator may instead, or additionally, be stored in non-volatile memory 140 and/or memory 121. In some such examples, processing core 110-1 may set the data paths of multiplexer 130 initially during a boot sequence, and the data paths configured by processing core 110-1 may be fixed for a run-time operation of MCU 105 until a subsequent boot sequence. In some examples, processing core 110-1 may additionally, or instead, control the data paths of multiplexer 130 based on the access requests of processing cores 110 provided to memory interface subsystem 120 via interconnect 115.

Non-volatile memory 135 and non-volatile memory 140 may be representative of non-volatile computer-readable storage media that retains stored information even after power is removed. In some examples, non-volatile memories 135 and 140 may be located externally relative to MCU 105. In some examples, non-volatile memories 135 and 140 may be located internally relative to MCU 105. Examples of non-volatile memories 135 and 140 may include FeRAM MRAM, PCM, PRAM, and flash memory. In an example, non-volatile memories 135 and 140 may include one or more flash memory banks included to provide additional capacity to store instructions and data, such as XIP code, read-only data, secondary bootloader data, and other loadable instructions. Non-volatile memory 135 may include a first set of addresses dedicated to storing read-only data and/or secondary bootloader data, a second set of addresses dedicated to storing data written to non-volatile memory 135 by processing cores 110 via one of the memory interface controllers, and a third set of addresses dedicated to storing program instructions. Non-volatile memory 140 may include a first set of addresses dedicated to storing data written to non-volatile memory 140 by processing cores 110 via one of the memory interface controllers and a second set of addresses dedicated to storing program instructions. In some examples, non-volatile memory 135 and non-volatile memory 140 may include other types of non-volatile memory or combinations or variations thereof.

By way of a first example, in operation, processing core 110-1 is tasked with designating one of non-volatile memory 135 and non-volatile memory 140 as the active memory for reading, and accordingly, processing core 110-1 configures multiplexer 130 to couple the designated flash memory to the read memory interface controller 126 and to couple the other flash memory to write memory interface controller 128 using enable signal 123. In this example, processing core 110-1 configures multiplexer 130 to couple the non-volatile memory 135 to the read memory interface controller 126 and to couple the non-volatile memory 140 to write memory interface controller 128. When any of the processing cores 110 provides an access request to memory interface subsystem 120 via interconnect 115 corresponding to a read request from flash memory, security module 124 of memory interface subsystem 120 receives the access request, performs safety and security operations related to the access request (e.g., encryption, decryption), and provides the access request to the read memory interface controller 126 for access to non-volatile memory 135. Then, memory interface controller 126 can access non-volatile memory 135 via the enabled data path to obtain or execute instructions or data requested in the read request and provide the instructions or data to the respective processing core 110 via interconnect 115.

By way of a second example, in operation, non-volatile memory 140 is designated for writing, and processing core 110-1 provides an access request to memory interface subsystem 120 via interconnect 115 corresponding to a write request to non-volatile memory 140. Processing core 122 of memory interface subsystem 120 receives the access request and identifies a set of addresses corresponding to non-volatile memory 140 based on the access request. Memory interface controller 128 can access non-volatile memory 140 via the enabled data path to write instructions or data indicated in the write request.

By way of a third example, during a start-up sequence of system 100 before run-time operations (e.g., a secondary bootloader sequence), processing core 110-1 may be configured to identify an active indicator 111 from non-volatile memory 135, which may be a flag, a value, or another indicator that indicates whether non-volatile memory 135 or non-volatile memory 140 is the active memory device for reading. In one such example, active indicator 111 may indicate whether non-volatile memory 135 or non-volatile memory 140 was written to last, and thus, may be storing active program instructions to be executed by one or more of processing cores 110 following the start-up sequence. Based on the value of active indicator 111, processing core 110-1 may configure multiplexer 130 to couple the designated memory to the read memory interface controller 126 and to couple the other flash memory to write memory interface controller 128 using enable signal 123. Thereafter, any of the processing cores 110 may provide an access request to memory interface subsystem 120 via interconnect 115 corresponding to a read request for the active program instructions from the active memory designated by the active indicator 111. Upon receiving the read request, memory interface controller 126 can communicate with non-volatile memory 135 or non-volatile memory 140 via the enabled data path based on the read request. Memory interface controller 126 can access non-volatile memory 135 to obtain the instructions requested in the read request and provide the instructions to processing core 110-1 via interconnect 115.

By way of a fourth example, processing cores 110-1 and 110-2 provide multiple access requests to memory interface subsystem 120 for access to non-volatile memories 135 and 140. The access requests may include multiple write requests and a read request. Security module 124 may receive the read request and perform safety and security operations accordingly. Processing core 122 may receive the write requests and may be configured to identify the different types of access requests and determine a priority among the write requests. In some examples, the memory may support multiple types of operations simultaneously. For example, the memory may support firmware-over-the-air (FOTA) update operations, which include high-priority time sensitive writes, and operations that cause the memory to act as an EEPROM memory with slow, low priority writes. Other types of writes may have an intermediate priority. Processing core 122 may be configured to determine that write requests correspond to a particular type of operation and/or priority and may schedule them accordingly. In some examples, processing core 122 may be configured to determine that update operations (e.g., firmware-over-the-air (FOTA) update operations) may be higher priority than other write requests. As explained above, processing core 110-1 may be configured to enable data paths of multiplexer 130 such that write memory interface controller 126 can perform the read request at one of non-volatile memories 135 and 140 via a first enabled data path and such that memory interface controller 128 can perform the write requests, in an order based on the determined arbitration of the write requests by processing core 122, at the other one of non-volatile memories 135 and 140 via a second enabled data path. In this way, processing core 110-1 may be configured to enable data paths of multiplexer 130 to allow memory interface controllers 126 and 128 to perform respective operations sequentially or concurrently without downtime between the access requests.

By way of a fifth example, processing core 110-1 may configure multiplexer 130 to couple non-volatile memory 135 to the write memory interface controller 128, and processing cores 110-1 and 110-2 provide multiple access requests to memory interface subsystem 120 for access to non-volatile memory 135. The access requests may both include write requests. Processing core 122 may receive the write requests from processing cores 110-1 and 110-2 via interconnect 115 and may be configured to determine a priority among the write requests. Processing core 122 may determine a first set of addresses of non-volatile memory 135 to which data and/or instructions may be written via memory interface controller 128. Following performance of the first write request, processing core 122 may be configured to gather information (e.g., statistics, metrics, parameters) associated with non-volatile memory 135 and the write request. For example, processing core 122 may identify the set of addresses written to based on the write request, the duration of the write request, the temperature of non-volatile memory 135 during the write request, the number of times the set of addresses has been written over, and the like. Based on the information, processing core 122 may be configured to determine a second set of addresses of non-volatile memory 135 to which data and/or instructions may be written via memory interface controller 128 for the second write request. The second set of addresses may include some or none of the same addresses as the first set of addresses. In this way, processing core 122 may advantageously increase the endurance and lifespan of non-volatile memory 135.

These examples discuss only a few situations and a few types of access requests, however, combinations and variations of request for access to different types of memory may be contemplated. Regardless of the request type, memory interface subsystem 120 can prioritize access to non-volatile memory 135 and non-volatile memory 140 to ensure that requests are performed in an order that at least increases processing efficiency of processing cores 110 while also increasing write endurance of non-volatile memories 135 and 140.

FIG. 2 illustrates a series of steps for controlling access to memory devices in an implementation. FIG. 2 shows process 200, which references elements of FIG. 1. Process 200 may be implemented by one or more components of a processing system, such as MCU 105 of FIG. 1. Accordingly, process 200 may be implemented in hardware, firmware, and/or software, or combinations or variations thereof.

In operation 205, processing core 110-1 of MCU 105 reads active indicator 111 from one of the memories of or coupled to MCU 105, such as one or more of non-volatile memory 135, non-volatile memory 140, and memory 121. Active indicator 111 may include a flag, a value, or another indication that indicates a designation of memories for reading and writing by respective memory interface controllers.

In operation 210, processing core 110-1 identifies, based on the active indicator 111 and/or other indicator, one of non-volatile memory 135 and non-volatile memory 140 as being designated for reading and the other of non-volatile memory 135 and non-volatile memory 140 as being designated for writing.

In operation 215, processing core 110-1 causes multiplexer 130 to selectably couple one of memory interface controllers 126 and 128 to one of non-volatile memories 135 and 140 and the other of memory interface controllers 126 and 128 to the other of non-volatile memories 135 and 140 based on the designation identified in active indicator 111. Accordingly in the steps that follow, the processing core 110-1 configures multiplexer 130 to couple one of non-volatile memory 135 and non-volatile memory 140 to a read path that includes security module 124 and read memory interface controller 126 and couples the other to a write path that includes processing core 122 and write memory interface controller 128.

In various examples, processing core 110-1 may be configured to control, via multiplexer 130, the data paths of multiplexer 130 by providing enable signal 123 to multiplexer 130. In some such examples, processing core 110-1 configures multiplexer 130 based on enable signal 123 once during a boot sequence, such that for access request during a run-time sequence can be directed to non-volatile memories 135 and 140 via respective coupled data paths between memory interface controllers 126 and 128 and non-volatile memories 135 and 140. In some such examples, processing core 110-1 may configure, or re-configure, the data paths between the memory interface controllers and non-volatile memories during the run-time sequence based on an access request. Regardless of the timing of the configuration, the read path and write paths are configured to service their respective types of access requests.

An access request may refer to a read request whereby processing cores 110 reads instructions or data from one or more addresses of memory 121, non-volatile memory 135, or non-volatile memory 140 to perform processing or computations using the instructions or data, or the access request may refer to a write request whereby processing cores 110 writes data to one or more addresses of memory 121, non-volatile memory 135, or non-volatile memory 140. In various examples, processing cores 110 may provide various access requests simultaneously or sequentially to memory interface subsystem 120 via interconnect 115. Security module 124 may receive read requests provided by processing cores 110, and processing core 122 may receive write requests provided by processing cores 110.

For a given access request corresponding to a read operation, memory interface controller 126 can access an external memory via an enabled data path, based on enable signal 123 provided to multiplexer 130 by processing core 110-1, to read from the memory. Similarly, for a given access request corresponding to a write operation, memory interface controller 128 can access a flash memory via a different enable data path, based on enable signal 123, to write to the memory. In this way, memory interface controller 126 can communicate with either or both non-volatile memory 135 and non-volatile memory 140 for a given read request, and memory interface controller 128 can communicate with either or both non-volatile memory 135 and non-volatile memory 140 for a given write request.

In various examples, processing core 122 may be configured to determine a priority among the access requests based on receiving multiple access requests for write operations. In such examples, this may entail determining the type of write request (e.g., data flash, FOTA, EEPROM) from a processing core, the processing core requesting access at the given time, other ongoing access requests, and the like. Based on the priorities of the access requests for the given time, processing core 122 may provide or gate access requests to memory interface controller 128 in a sequential order corresponding to the priority of the access requests. Memory interface controller 128 can access a respective memory using a data path enabled by processing core 110-1 to perform priority write requests in an order from highest priority to lowest priority.

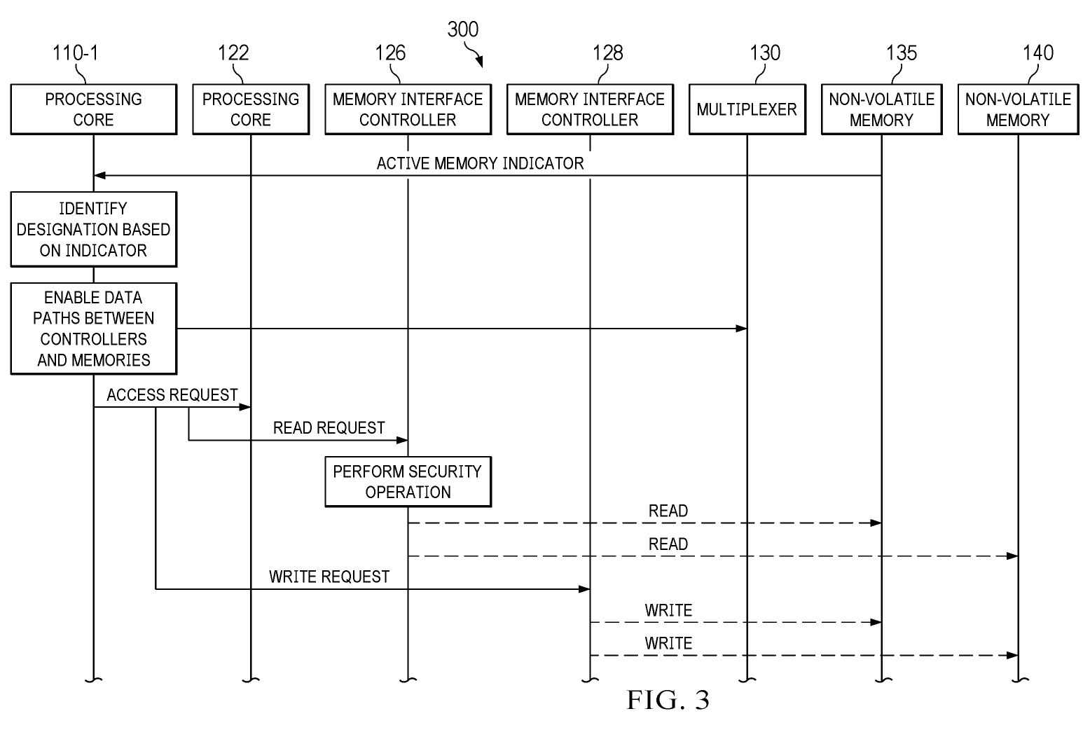

FIG. 3 illustrates an example sequence diagram demonstrating access between elements of a system in accordance with an implementation. FIG. 3 shows sequence 300, which references elements of FIG. 1.

In sequence 300, processing core 110-1 may begin a start-up sequence whereby processing core 110-1 obtains read-only data, executes secondary boot loader code, and initializes elements of system 100. During a boot phase of this sequence, processing core 110-1 may first be configured to obtain read-only data from non-volatile memory 135. In some examples, processing core 110-1 may instead be configured to obtain the read-only data from non-volatile memory 140 or memory 121. Following the boot phase, during a secondary bootloader phase of the start-up sequence, processing core 110-1 may be configured to obtain an active memory indicator (active indicator 111) from non-volatile memory 135 or non-volatile memory 140. In some examples, the active memory indicator may be a flag, a value, or another indicator that indicates whether non-volatile memory 135 or non-volatile memory 140 is the active memory device. In some such examples, the active memory indicator may indicate whether non-volatile memory 135 or non-volatile memory 140 was written to last, and thus, may be currently storing active program instructions to be executed by one or more of processing cores 110 following the boot sequence.

Based on the value of the active memory indicator, processing core 110-1 may identify and enable one or more data paths between memory interface controller 126 and non-volatile memory 135 or non-volatile memory 140 and between memory interface controller 128 and non-volatile memory 135 or non-volatile memory 140. In various examples, processing core 110-1 may provide enable signal 123 to multiplexer 130 to enable the data paths accordingly based on the access requests. Based on receiving enable signal 123, multiplexer 130 may be caused to couple one of memory interface controllers 126 and 128 to one of non-volatile memories 135 and 140 and the other of memory interface controllers 126 and 128 to the other of non-volatile memories 135 and 140.

Next, during an execution sequence whereby processing cores 110 execute program instructions from various memories, processing core 110-1 may provide an access request to memory interface subsystem 120 via interconnect 115. The access request may include a write request or a read request. The access request may specify or indicate a set of addresses and/or the instructions or data to be executed by processing core 110-1. For example, for an access request corresponding to a read request from non-volatile memory 135, security module 124 can receive the access request, identify a set of addresses corresponding to non-volatile memory 135 based on the access request, and perform a cryptographic operation before providing the read request to memory interface controller 126 to access non-volatile memory 135 via an enabled data path. Then, memory interface controller 126 can access non-volatile memory 135 to obtain the instructions or data requested in the read request and provide the instructions or data to processing core 110-1 via interconnect 115. In some examples, security module 124 may instead, or additionally, perform a cryptographic operation after obtaining data from non-volatile memory 135. For example, security module 124 may perform an ECC check, decrypt data obtained from non-volatile memory 135, and perform an authentication operation on the data before providing the data to processing cores 110 via interconnect 115. For an example whereby the access request corresponds to a write request to non-volatile memory 135, processing core 122 can receive the access request and identify a set of addresses corresponding to non-volatile memory 135 based on the access request. Based on the access request corresponding to a write request, processing core 122 may be configured to provide the write request to memory interface controller 128 for memory interface controller 128 to communicate with non-volatile memory 135 via a data path. Memory interface controller 128 can access non-volatile memory 135 to write instructions or data indicated in the write request.

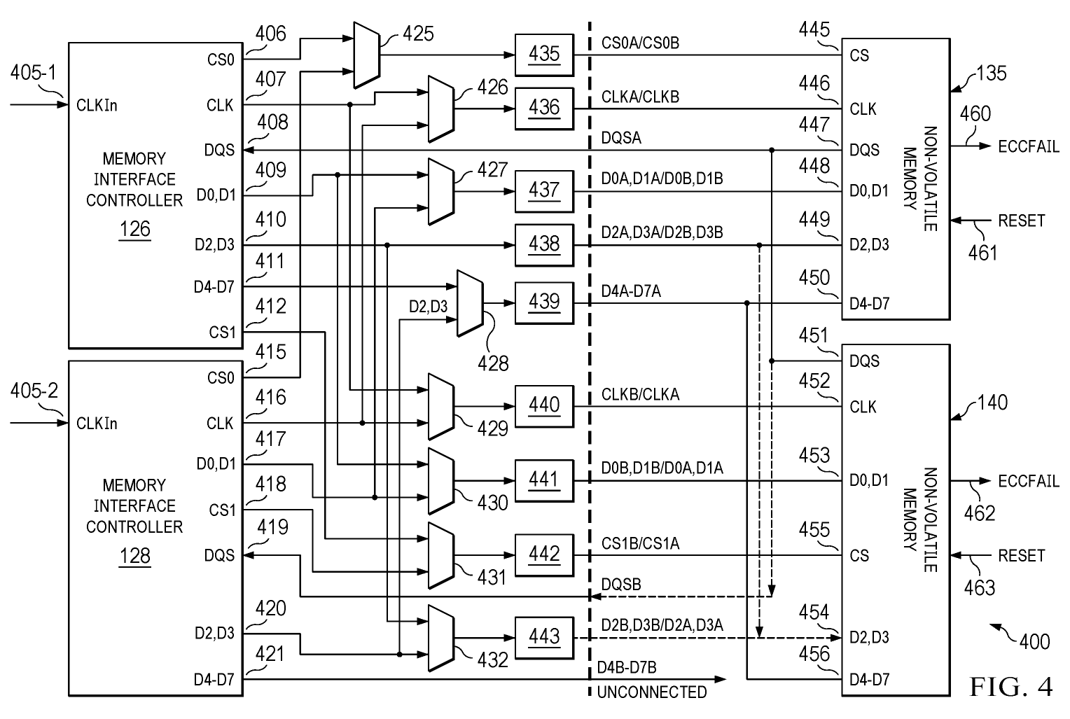

FIG. 4 illustrates an example architecture of components of a system configurable to perform memory access control in an implementation. FIG. 4 shows architecture 400, which includes memory interface controller 126, memory interface controller 128, non-volatile memory 135, non-volatile memory 140, various inputs and outputs thereof, various multiplexers of multiplexer 130 coupled to pins of memory interface controllers 126 and 128, and various IO pads coupled to the multiplexers and to non-volatile memories 135 and 140.

In various examples, each of memory interface controller 126, memory interface controller 128, non-volatile memory 135, and non-volatile memory 140 include sets of inputs and outputs (e.g., ports and/or pins) with which a respective memory interface controller may be coupled to non-volatile memory 135 and non-volatile memory 140 via one or more lines, traces, or other conductive features and with which memory interface controllers 126 and 128 can communicate with non-volatile memories 135 and 140. More specifically, memory interface controller 126 may include a set of inputs and outputs to communicatively couple to non-volatile memories 135 and 140, which may include a first chip select output 406, a clock output 407, a data strobe input 408, a first set of serial data outputs 409 (e.g., D0 & D1), a second set of serial data outputs 410 (e.g., D2 & D3), a third set of serial data outputs 411 (e.g., D4-D7), and a second chip select output 412. Memory interface controller 128 may include a set of inputs and outputs to communicatively couple to non-volatile memories 135 and 140, which may include a first chip select output 415, a clock output 416, a first set of serial data outputs 417 (e.g., D0 & D1), a second chip select output 418, a data strobe input 419, a second set of serial data outputs 420 (e.g., D2 & D3), and a third set of serial data outputs 421 (e.g., D4-D7).

Non-volatile memory 135 may include inputs and outputs implemented as pins such as chip select input pin 445, clock input pin 446, data strobe output pin 447, a first set of serial data input pins 448 (e.g., D0 & D1), a second set of serial data input pins 449 (e.g., D2 & D3), and a third set of serial data input pins 450 (e.g., D4-D7). Non-volatile memory 140 may include inputs and outputs implemented as pins such as chip select input pin 455, clock input pin 452, data strobe output pin 451, a first set of serial data input pins 453 (e.g., D0 & D1), and a second set of serial data input pins 454 (e.g., D2-D7). Based on an interfacing mode (e.g., an octal serial peripheral interface (OSPI) mode, a quad serial peripheral interface (QSPI) mode), combinations and variations of the above signals may be used.

The inputs and outputs of the memory interface controllers 126 and 128 may be coupled to the inputs and outputs of non-volatile memories 135 and 140 via multiplexers 425-432 (e.g., components of multiplexer 130 of FIG. 1) and a set of pins 435-443.

First chip select output 406 and second chip select output 412 of memory interface controller 126, and first chip select output 415 and second chip select output 418 of memory interface controller 128 may be representative of chip selection signals used to wake up one or more of the memory interface controllers and non-volatile memories to send and receive data. More specifically, first chip select output 406 and first chip select output 415 may be first chip selection signals output by memory interface controller 126 and memory interface controller 128, respectively, that are received by non-volatile memory 135 at chip select input pin 445 via multiplexer 425 and pin 435, while second chip select output 412 and second chip select output 418 may be second chip selection signals output by memory interface controller 126 and memory interface controller 128, respectively, that are received by non-volatile memory 140 at chip select input pin 455 via multiplexer 431 and pin 442.

Clock outputs 407 and 416 may be representative of clock signals based on clock signals 405-1 and 405-2, respectively, with which synchronize one or more of the memory interface controllers and the non-volatile memories during sending and receiving of data. Non-volatile memory 135 may receive one of clock outputs 407 and 416 at clock input pin 446, and non-volatile memory 140 may receive one of clock outputs 407 and 416 at clock input pin 452. In various examples, memory interface controller 126 may receive clock signal 405-1 from a timing circuit, an oscillator, or another device, and similarly, memory interface controller 128 may receive clock signal 405-2 from a timing circuit, an oscillator, or another device. In some embodiments, clock signals 405-1 and 405-2 may be the same clock signal. In some embodiments, clock signals 405-1 and 405-2 may be different clock signals. Memory interface controller 126 may output clock output 407 to multiplexers 426 and 429, and memory interface controller 128 may output clock output 416 to multiplexers 426 and 429. Multiplexer 426 may be coupled to pin 436, which may be coupled to provide one of clock outputs 407 and 416 to non-volatile memory 135. Similarly, multiplexer 429 may be coupled to pin 440, which may be coupled to provide one of clock outputs 407 and 417 to non-volatile memory 140. Multiplexers 426 and 429 may be configured to select one of the two input clock outputs to provide to the memory devices.

Data strobe inputs 408 and 419 may be representative of data strobe signals, which may be provided by one of the non-volatile memories to cause a memory interface controller to sample read data. Memory interface controller 126 may be coupled to receive data strobe input 408 from non-volatile memories 135 and 140 via data strobe output pins 447 and 451, respectively. Similarly, memory interface controller 128 may be coupled to receive data strobe input 419 from non-volatile memories 135 and 140 via data strobe output pins 447 and 451, respectively.

The first sets of serial data outputs 409 and 417, the second sets of serial data outputs 410 and 420, and the third set of serial data outputs 411 and 421 (collectively referred to as the serial data outputs) may be representative of data signals output by memory interface controllers 126 and 128. More specifically, the first sets of serial data outputs 409 and 417 may be provided to multiplexers 427 and 430. Multiplexer 427 may be coupled to provide a selected output(s) among one of the first sets of serial data outputs 409 and 417 to non-volatile memory 135 at the first set of serial data input pins 448 via pin 437. Multiplexer 430 may be coupled to provide a selected output(s) among one of the first sets of serial data outputs 409 and 417 to non-volatile memory 140 at the first set of serial data input pins 453 via pin 441. The second sets of serial data outputs 410 and 420 may be provided to multiplexers 428 and 432. Multiplexer 428 may be coupled to provide a selected output(s) among one of the second sets of serial data outputs 410 and 420 to non-volatile memory 135 at the second set of serial data input pins 449 via pin 438, and multiplexer 432 may be coupled to provide another selected output(s) among one of the second set of serial data outputs 410 and 420 to non-volatile memory 140 at the second set of serial data input pins 454 via pin 438. Memory interface controllers 126 and 128 may provide the third set of serial data outputs 411 to multiplexer 428. Multiplexer 428 may be coupled to a selected output(s) among one of the third set of serial data outputs 411 to non-volatile memory 135 at the third set of serial data input pins 450 and/or to non-volatile memory 140 at the second set of serial data input pins 454 via pin 439. In various examples, the third set of serial data outputs 421 might not be provided to non-volatile memory 135 or to non-volatile memory 140.

In some examples, based on a first mode (e.g., OSPI mode), a first subset of the above inputs and outputs may be used (e.g., 8 signals). In some examples, based on a second mode (e.g., QSPI mode), a second subset of the above inputs and outputs may be used, which may include fewer signals than the first subset of signals (e.g., 4 signals). In some examples, based on a third mode (e.g., SPI mode), a third subset of the above inputs and outputs may be used, which may include fewer signals than the second subset of signals (e.g., 2 signals). In some examples, memory interface controller 126 may operate in the first mode in communication with non-volatile memory 135, and memory interface controller 128 may operate in the second or third mode in communication with non-volatile memory 140. In some examples, memory interface controller 128 may operate in the first mode in communication with non-volatile memory 135, and memory interface controller 126 may operate in the second or third mode in communication with non-volatile memory 140. In these ways, various combinations of signals may be used to send and receive data between the memory interface controllers and the non-volatile memories. Other combinations or variations may be contemplated.

In operation, a chip selection signal (e.g., one of first chip selection outputs 406 and 415, one of second chip selection outputs 412 and 418) may be provided from one of memory interface controllers 126 and 128 to one of non-volatile memories 135 and 140 to wake up a respective flash memory device to begin sending data to a memory interface controller or to begin receiving data from a memory interface controller. A data strobe signal (e.g., data strobe inputs 408 and 417) may be provided from one of non-volatile memories 135 and 140 to one of memory interface controllers 126 and 128 for a memory interface controller to sample read data sent out by a non-volatile memory, if necessary. The multiplexers can direct data to or from a certain memory device from a memory interface controller. For example, multiplexers 427, 428, and 430 may control data flow to or from memory interface controller 126 and non-volatile memory 135, to or from memory interface controller 126 and non-volatile memory 140, to or from memory interface controller 128 and non-volatile memory 135, and to or from memory interface controller 128 and non-volatile memory 140.

In a first multiplexer mode, memory interface controller 126 may be configured to perform a read or an XIP request from non-volatile memory 135 in 8-wire octal mode, and memory interface controller 128 may be configured to perform a write request that includes writing new firmware to non-volatile memory 140 in 2-wire SPI mode. In this case, multiplexers 425, 426, 427, and 428 may be configured to route first chip selection output 406, clock output 407, and the first set of serial data outputs 409 to non-volatile memory 135 via pins 435, 436, and 437, respectively, while multiplexers 429, 430, and 431 may be configured to route signals clock output 416, the first set of serial data outputs 417, and the second chip selection output 418 to non-volatile memory 140 via pins 440, 441, and 442, respectively. In this mode, the second set of serial data outputs 410 and the third set of serial data outputs 411 may be provided to non-volatile memories 135 and 140, and the second set of serial data outputs 420 and the third set of serial data outputs 421 might not be provided to non-volatile memories 135 and 140. As such, the second set of serial data outputs 420 and the third set of serial data outputs 421 might not be provided to any of the multiplexers, which may reduce the number of pins of memory interface controller 128 used in this mode.

In a second multiplexer mode, memory interface controller 126 may be configured to perform a read or an XIP request from non-volatile memory 140 based on the newly written/downloaded firmware in non-volatile memory 140 from the write request performed by memory interface controller 128 in the first multiplexer mode, and memory interface controller 128 may be configured to perform a further write request including another firmware update to non-volatile memory 135. In this case, multiplexers 425, 426, and 427 may be configured to route first chip selection output 415, clock output 416, and the first set of serial data outputs 417 of memory interface controller 128 to non-volatile memory 135 via pins 435, 436, and 437, respectively, while multiplexers 429, 430, and 431 may be configured to route the second chip selection output 412, clock output 407, and the first set of serial data outputs 409 of memory interface controller 126 to non-volatile memory 140 via pins 442, 440, and 441, respectively. Thus, one of non-volatile memories 135 and 140 may be designated for reading during a multiplexer mode, and the other may be designated for writing during the multiplexer mode.

In a third multiplexer mode, memory interface controller 126 may be configured to perform a read or an XIP request from non-volatile memory 135 in 8-wire octal mode, and memory interface controller 128 may be configured to perform a write request that includes writing new firmware to non-volatile memory 140 in 4-wire QSPI mode. In this mode, multiplexers 425, 426, 427, and 428 may be configured to route first chip selection output 406, clock output 407, the first set of serial data outputs 409, and the second set of serial data outputs 410 to non-volatile memory 135 via pins 435, 436, 437, and 438 respectively, while multiplexers 429, 430, 431, and 432 may be configured to route signals clock output 416, the first set of serial data outputs 417, the second chip selection output 418, and the second set of serial output data 420 to non-volatile memory 140 via pins 440, 441, 442, and 443, respectively. In this mode, the third set of serial data outputs 421 might not be provided to non-volatile memories 135 and 140.

In a fourth multiplexer mode, memory interface controller 126 may be configured to perform a read or an XIP request from non-volatile memory 140 based on the newly written/downloaded firmware in non-volatile memory 140 from the write request performed by memory interface controller 128 in the third multiplexer mode, and memory interface controller 128 may be configured to perform a further write request including another firmware update to non-volatile memory 135. In this case, multiplexers 425, 426, 427, and 428 may be configured to route first chip selection output 415, clock output 416, the first set of serial data outputs 417, and the second set of serial data outputs 420 of memory interface controller 128 to non-volatile memory 135 via pins 435, 436, 437, and 438 respectively, while multiplexers 429, 430, 431, and 432 may be configured to route the second chip selection output 412, clock output 407, the first set of serial data outputs 409, and the second set of serial data outputs 410 of memory interface controller 126 to non-volatile memory 140 via pins 442, 440, 441, and 443, respectively. Thus, one of non-volatile memories 135 and 140 may be designated for reading during a multiplexer mode, and the other may be designated for writing during the multiplexer mode.

In various examples, the pins of the devices may be configured to operate according to a serial port interface protocol (e.g., OSPI, QSPI, xPSI). Other configurations and protocols may be used in some embodiments. Regardless, the coupling and pin scheme demonstrated in architecture 400 may provide for a reduced pin-count architecture that enables concurrent read and write use-cases for multiple flash memories. In various embodiments, architecture 400 may enable a system to use a highest pin-count mode (e.g., OSPI) for read and execute-in-place requests for increased throughput while also using a lowest pin-count mode (e.g., SPI) for write requests.

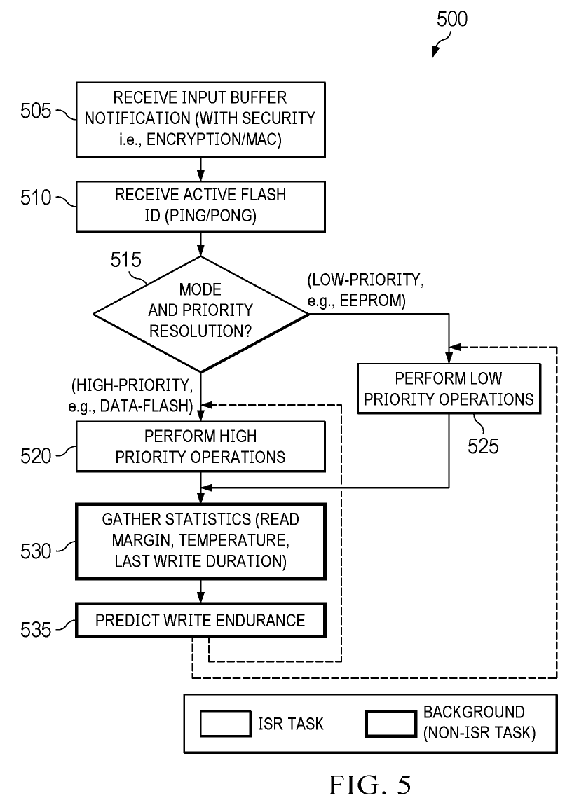

FIG. 5 illustrates an example flow chart for controlling access to memory devices in an implementation. FIG. 5 shows process 500, which references elements of FIG. 1. Process 500 may be implemented by one or more components of a processing system, such as MCU 105 of FIG. 1. Accordingly, process 500 may be implemented in hardware, firmware, and/or software, or combinations or variations thereof.

In operation 505, processing core 122 of MCU 105 receives an input buffer notification from processing core 110-1. The input buffer notification may indicate a write of data to a buffer of, or coupled to, processing core 122. In various examples, this may occur following a boot of MCU 105, which may trigger processing core 110-1 to perform boot and secondary bootloader processes to begin executing program instructions and enable functionality of MCU 105 and other peripheral devices coupled to MCU 105.

In operation 510, during this phase, processing core 110-1 may be configured to obtain an active memory indicator (active indicator 111) from non-volatile memory 135, and processing core 122 may obtain the active memory indicator from processing core 110-1. In some examples, the active memory indicator may be a flag, a value, or another indicator that indicates whether non-volatile memory 135 or non-volatile memory 140 is the active memory device. In other words, the active memory indicator may indicate whether non-volatile memory 135 or non-volatile memory 140 was written to last, and thus, may be currently storing active program instructions to be executed by one or more of processing cores 110 following the boot sequence. Based on the active memory indicator, processing core 110-1 may further be configured to provide an indication of the active memory indicator to processing core 122 of memory interface subsystem 120 to indicate to processing core 122 which of non-volatile memory 135 or non-volatile memory 140 is the active memory device. In other words, processing core 122, in response to receiving this indication, may identify which memory is available for writing operations.

Next, during an execution sequence whereby processing cores 110 execute program instructions from various memories, processing core 110-1 may provide write requests to processing core 122 via interconnect 115. The write requests may specify or indicate a set of addresses and/or the instructions or data to be executed by processing cores 110 as well as a specific type of write operation to be performed at the given memory (e.g., data flash, FOTA).

In operation 515, processing core 122 may be configured to identify the different types of write requests and determine a priority among the write requests. In some examples, processing core 122 may be configured to determine that write requests corresponding to data flash operations may be higher priority than other writes, such as an EEPROM operation for example. In some examples, processing core 122 may be configured to determine that FOTA operations may be higher priority than other writes such as data flash writes and EEPROM writes. Based on the determined arbitration of the access requests, processing core 122 may be configured to generate a queue or prioritization among the write requests and provide the write requests in a prioritized fashion to memory interface controller 128 to allow memory interface controller 128 to perform respective operations sequentially or concurrently based on priority.

Following an example where data flash operations and other high priority write requests are weighed as higher priority relative to other write requests, in operation 520, processing core 122 can identify the high priority write requests and provide the write requests, in a prioritized order, to memory interface controller 128 to execute high priority operations (e.g., a data flash operation) at one or more of non-volatile memory 135 and non-volatile memory 140 based on a given access request. In such examples, if processing core 122 has not received any high priority access requests, processing core 122 can identify lower priority requests, such as an EEPROM operation, and provide the operation to memory interface controller 128 to perform the lower priority access requests at one or more of non-volatile memory 135 and non-volatile memory 140 based on a given access request, such as in operation 525.

In operation 530, following performance of one or more write requests, processing core 122 may be configured to gather information (e.g., statistics, metrics, parameters) associated with the accessed memory (e.g., non-volatile memory 135 and/or non-volatile memory 140) and the write request. For example, processing core 122 may identify the set of addresses written to based on a write request, the duration of a write request, the temperature of the memory during the write request, the number of times the set of addresses has been written over, and the like. Based on the information, in operation 535, processing core 122 may be configured to predict the write endurance of the memory at the various physical addresses of the memory. In other words, processing core 122 may be configured to determine the endurance of the set of physical addresses of a given memory, such as how many additional times program instructions or data can be written to the set of addresses. Based on the determination, processing core 122 may update a mapping between virtual addresses in the write operations acted upon in operations 520 and 525 and the corresponding physical addresses in non-volatile memory 135 and/or non-volatile memory 140 such that subsequent access requests use or avoid physical address locations to increase endurance of the memory. For example, for a subsequent write request, processing core 122 may direct memory interface controller 128 to use different sets of physical addresses when writing data associated with the same set of physical addresses to a given memory. The different set of addresses may include some or none of the same addresses as the previous set of addresses. In various examples, processing core 122 may perform operations 530 and 535 in the background, or as non-interrupt service routine (non-ISR) tasks. In this way, processing core 122 may advantageously increase the endurance and lifespan of non-volatile memory 135 and non-volatile memory 140.

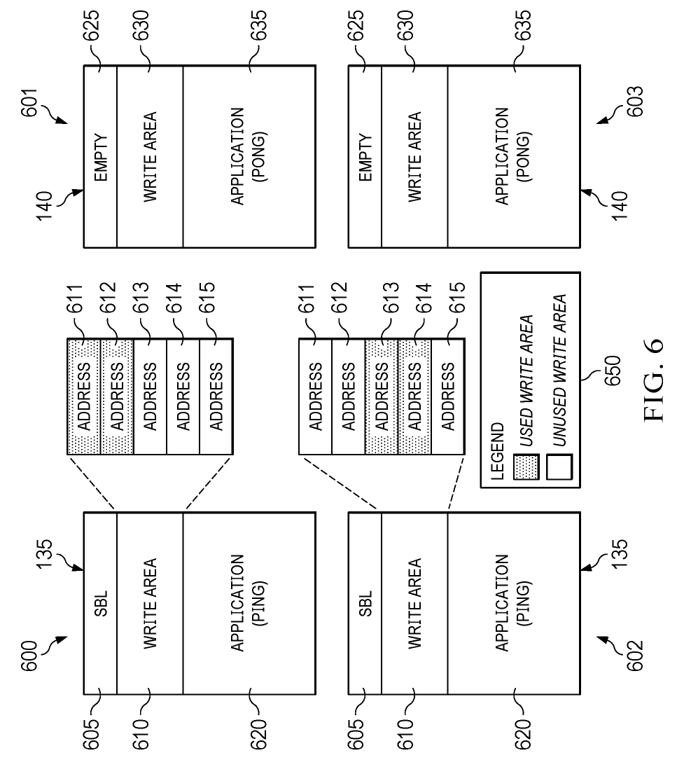

FIG. 6 illustrates example aspects of non-volatile memory devices in an implementation. FIG. 6 shows aspects 600, 601, 602, and 603, which reference elements of system 100 of FIG. 1. Aspects 600 and 602 show non-volatile memory 135 and elements thereof, and aspects 601 and 603 show non-volatile memory 140 and elements thereof.

Non-volatile memory 135 and non-volatile memory 140 may be representative of non-volatile computer-readable storage media located externally with respect to a system or system-on-chip, such as system 100 or MCU 105 thereof. For example, non-volatile memories 135 and 140 may include one or more flash memory banks included to provide additional capacity to store instructions and data, such as XIP code, read-only data, secondary bootloader data, and other loadable instructions.

Non-volatile memory 135 may include a first set of physical addresses dedicated to storing read-only data and/or secondary bootloader data, secondary bootloader area 605, a second set of physical addresses dedicated to storing data written to non-volatile memory 135 by processing cores 110 via one of the memory interface controllers, write area 610, and a third set of physical addresses dedicated to storing program instructions, application area 620. In use, one or more processors, such as processing cores 110 and processing core 122, may read from and write to the different sets of physical addresses. For example, for write requests, processing cores 110 may write to one or more of physical addresses 611, 612, 613, 614, and 615 of write area 610.

In an example illustrated in aspect 600, processing core 122 may determine physical addresses 611 and 612 for use for a given write request as denoted by the gradient pattern in legend 650. In a subsequent example, such as one shown in aspect 602, processing core 122 may determine physical addresses 613 and 614 for use for a given write request as denoted by the gradient pattern in legend 650. Processing core 122 may determine which physical addresses of write area 610 to use for each write request based on statistics gathered during each write request (e.g., write duration, temperature of non-volatile memory 135). In this way, processing core 122 may advantageously increase the endurance and lifespan of non-volatile memory 135 as physical addresses 611, 612, 613, 614, and 615 may be selected and written to based on real-time statistics that may identify overuse of one or more of the physical addresses, for example.

Non-volatile memory 140 may include a first set of physical addresses dedicated to storing data written to non-volatile memory 140 by processing cores 110 via one of the memory interface controllers, write area 630, and a second set of physical addresses dedicated to storing program instructions, application area 635. In some examples, non-volatile memory 140 might include a set of physical addresses dedicated to storing read-only data and/or secondary bootloader data, such as secondary bootloader area 625. However, in some examples, secondary bootloader area 625 may be empty. Similar to write area 610 of non-volatile memory 135, write area 630 of non-volatile memory 140 may also include various physical addresses. Processing core 122 may cycle through variations and combinations of the sets of physical addresses based on statistics corresponding to write requests associated with non-volatile memory 140 and corresponding to non-volatile memory 140 itself.

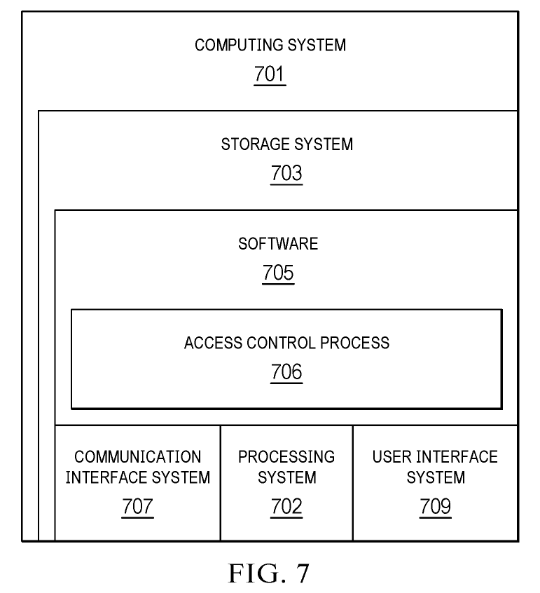

FIG. 7 illustrates computing system 701 to perform memory access prioritization, arbitration, and control according to an implementation of the present technology. Computing system 701 is representative of any system or collection of systems with which the various operational architectures, processes, scenarios, and sequences disclosed herein for memory access control may be employed. Computing system 701 may be implemented as a single apparatus, system, or device or may be implemented in a distributed manner as multiple apparatuses, systems, or devices. Computing system 701 includes, but is not limited to, processing system 702, storage system 703, software 705, communication interface system 707, and user interface system 709 (optional). Processing system 702 is operatively coupled with storage system 703, communication interface system 707, and user interface system 709. Computing system 701 may be representative of a cloud computing device, distributed computing device, or the like.

Processing system 702 loads and executes software 705 from storage system 703. Software 705 includes and implements access control process 706, which is representative of any of the access request analysis, prioritization, arbitration, and statistics gathering processes discussed with respect to the preceding Figures. When executed by processing system 702 to provide access functions, software 705 directs processing system 702 to operate as described herein for at least the various processes, operational scenarios, and sequences discussed in the foregoing implementations. Computing system 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including access control process 706) may be implemented in program instructions and among other functions may, when executed by processing system 702, direct processing system 702 to operate as described with respect to the various operational scenarios, sequences, and processes illustrated herein. For example, software 705 may include program instructions for implementing a risk-based scoring process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing system 701 is representative) overall from a general-purpose computing system into a special-purpose computing system customized to provide memory access as described herein. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

While some examples provided herein are described in the context of a system-on-chip, processor, microcontroller unit, circuitry, environment, or the like, the memory access methods, techniques, and systems described herein are not limited to such examples and may apply to a variety of other processes, systems, applications, devices, and the like. Aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Unless the context clearly requires otherwise, throughout the description and the claims, the words "comprise," "comprising," and the like are to be construed in an inclusive sense, as opposed to an exclusive or exhaustive sense; that is to say, in the sense of "including, but not limited to." As used herein, the terms "connected," "coupled," or any variant thereof means any connection or coupling, either direct or indirect, between two or more elements; the coupling or connection between the elements can be physical, logical, or a combination thereof. Additionally, the words "herein," "above," "below," and words of similar import, when used in this application, refer to this application as a whole and not to any particular portions of this application. Where the context permits, words in the above Detailed Description using the singular or plural number may also include the plural or singular number respectively. The word "or," in reference to a list of two or more items, covers all of the following interpretations of the word: any of the items in the list, all of the items in the list, and any combination of the items in the list.

The phrases "in some examples," "according to some examples," "in the examples shown," "in other examples," and the like generally mean the particular feature, structure, or characteristic following the phrase is included in at least one implementation of the present technology, and may be included in more than one implementation. In addition, such phrases do not necessarily refer to the same example or different examples.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words "means for” but use of the term "for" in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A device, comprising:
a first memory interface controller;
a second memory interface controller;
a multiplexer coupled to the first and second memory interface controllers and configured to selectably couple a first of the first and second memory interface controllers to a first memory and to selectably couple a second of the first and second memory interface controllers to a second memory; and
a processing core coupled to the first and second memory interface controllers and to the multiplexer, wherein the processing core is configured to cause the multiplexer to selectably couple the first of the first and second memory interface controllers to the first memory and to selectably couple the second of the first and second memory interface controllers to the second memory.

2. The device of claim 1, wherein the processing core is configured to:
cause the multiplexer to selectably couple the first of the first and second memory interface controllers to the first memory based on the first memory being designated for reading; and
cause the multiplexer to selectably couple the second of the first and second memory interface controllers to the first memory based on the first memory being designated for writing.

3. The device of claim 1, wherein the processing core is configured to receive an indicator that designates the first memory for reading and the second memory for writing.

4. The device of claim 3, wherein the processing core is configured to read the indicator from at least one of the first memory and the second memory.

5. The device of claim 2, further comprising a safety and security module coupled to the first memory interface controller, wherein the safety and security module is configured to perform a cryptography operation prior to reading or writing to a respective memory.

6. The device of claim 3, wherein to cause the multiplexer to selectably couple the first of the first and second memory interface controllers to the first memory and to selectably couple the second of the first and second memory interface controllers to the second memory, the processing core is configured to provide an enable signal based on the indicator to the multiplexer.

7. The device of claim 1, further comprising an interconnect coupled to the processing core and coupled to the first and second memory interface controllers.

8. The device of claim 1, wherein the first memory comprises a non-volatile memory.

9. The device of claim 8, wherein the second memory comprises a non-volatile memory.

10. A device, comprising:
one or more computer-readable storage media; and
program instructions stored on the one or more computer-readable storage media that, based on being read and executed by a processing system, direct the processing system to:
read an indicator from one or more of a first memory and a second memory; and
cause a multiplexer to selectably couple a first of first and second memory interface controllers to the first memory and to selectably couple a second of the first and second memory interface controllers to the second memory based on the indicator.

11. The device of claim 10, wherein the program instructions further direct the processing system to:
cause the multiplexer to selectably couple the first of the first and second memory interface controllers to the first memory based on the first memory being designated for reading; and
cause the multiplexer to selectably couple the second of the first and second memory interface controllers to the first memory based on the first memory being designated for writing.

12. The device of claim 10, wherein the indicator designates the first memory for reading and the second memory for writing.

13. The device of claim 12, wherein to cause the multiplexer to selectably couple the first of the first and second memory interface controllers to the first memory and to selectably couple the second of the first and second memory interface controllers to the second memory, the program instructions direct the processing system to provide an enable signal based on the indicator to the multiplexer.

14. The device of claim 10, wherein the program instructions further direct the processing system to:
receive an access request;
identify a type of the access request;
based on the access request corresponding to reading, cause the first of the first and second memory interface controllers to perform the access request at the first memory via the multiplexer; and
based on the access request corresponding to writing, cause the second of the first and second memory interface controllers to perform the access request at the second memory via the multiplexer.

15. A method, comprising:
reading an indicator from one or more of a first memory and a second memory;
and
causing a multiplexer to selectably couple a first of first and second memory interface controllers to the first memory and to selectably couple a second of the first and second memory interface controllers to the second memory based on the indicator.

16. The method of claim 15, further comprising:
causing the multiplexer to selectably couple the first of the first and second memory interface controllers to the first memory based on the first memory being designated for reading; and
causing the multiplexer to selectably couple the second of the first and second memory interface controllers to the first memory based on the first memory being designated for writing.

17. The method of claim 16, wherein causing the multiplexer to selectably couple the first of the first and second memory interface controllers to the first memory and to selectably couple the second of the first and second memory interface controllers to the second memory comprises providing an enable signal based on the indicator to the multiplexer.

18. The method of claim 16, wherein the indicator designates the first memory for reading and the second memory for writing.

19. The method of claim 15, further comprising:
receiving an access request;
identifying a type of the access request;
based on the access request corresponding to reading, causing the first of the first and second memory interface controllers to perform the access request at the first memory via the multiplexer; and
based on the access request corresponding to writing, causing the second of the first and second memory interface controllers to perform the access request at the second memory via the multiplexer.

20. The method of claim 15, wherein the first memory and the second memory comprise non-volatile memory devices.
